(19) United States
(12) Patent Application Publication
(10) Pub. No.: US 2007/0059419 A1
(43) Pub. Date: Mar. 15, 2007

(54) Methods and compositions to improve mouth feel

(76) Inventors: Steven J. Catani, Athens, GA (US); Shyhyuan Liao, West Windsor, NJ (US); Melanie Loades, Surrey (GB)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/225,614

(22) Filed: Sep. 13, 2005

(51) Int. Cl. A23L 1/236

(52) U.S. Cl. 426/548

(57) ABSTRACT

Free-flowing powdered or granular low calorie sweetener compositions containing a high intensity sweetener and a food-grade gum are provided. These compositions, when added to a solid food or beverage provide improved mouth feel without significant caloric impact. Methods of producing these sweetener compositions and kits that incorporate such compositions are also provided.

### FIELD OF THE INVENTION

The present invention relates to a free-flowing sweetener composition containing a high intensity sweetener and a food-grade material. More particularly, the present invention relates to high intensity sweetener compositions suitable for custom dosing having an improved mouth feel when combined with a foodstuff. Methods of producing these sweetener compositions and kits containing such compositions are also provided.

### BACKGROUND OF THE INVENTION

Consumers add many flavors to foods they consume, thereby customizing those foods to their personal tastes. Most foods are sweetened. Sweeteners are added to beverages (e.g., coffees and teas), to cereals, to fruits, as toppings on baked goods, and in many other ways. Sweetening a product generally increases its appeal to consumers. This preference is found in all cultures, but is especially prevalent in western cultures.

Sweeteners are typically extracted from plants that produce them in various quantities and for various purposes. For example, sucrose, a nutritive sweetener in wide-spread use, is produced from many sources, e.g., sugar cane and sugar beet roots. Well-known processes are used to extract and purify sucrose from these and other plants. Other nutritive sweeteners, such as dextrose (glucose) and fructose, are also produced by various grain plants and may be extracted and purified by well-known processes. These sweeteners are collectively known as nutritive sweeteners because they not only provide sweetness but are also absorbable into the bloodstream of mammals and may be metabolized, providing energy for immediate use or for storage as fat. Also available to consumers are sweet flavorings that contain, for example, syrups, such as, corn syrups, molasses, and the like.

When a nutritive sweetener is used to sweeten a foodstuff, e.g., a beverage or a solid food product, it not only provides sweetness but also a distinctive mouth feel to the foodstuff. This mouth feel is an important part of the overall sensory experience of the consumer. The mouth feel provided by a pleasant sucrose sweetened beverage is often described as “substantial, not thin but also not syrupy, and not gummy or slimy.”

High intensity sweeteners are well known alternatives to nutritive sweeteners. Among the high intensity sweeteners in widespread use are aspartame, acesulfame, saccharine, cyclamate, neotame, sucralose, brazzein and other protein based sweeteners, stevia and other plant extracts, salts, and derivatives thereof. High intensity sweeteners provide sweetness without the calories and other metabolic impacts of the nutritive sweeteners. In many cases, high intensity sweeteners provide a sweet flavor that is preferred to nutritive sweeteners. Some high intensity sweeteners, such as, aspartame, are nutritive, but are so intense that they still provide negligible calories because very small amounts are required. Other high intensity sweeteners, such as, sucralose, are not absorbed when ingested and are, therefore, non-nutritive sweeteners.

High intensity sweeteners are typically available in granular formulations designed to provide sweetness on a spoon-for-spoon basis with sucrose. These granular formulations may be stored in small packets or sachets, generally holding one or two teaspoon equivalents of sucrose sweetness. High intensity sweeteners may also be processed in tablet form, each generally containing one or two teaspoon equivalents of sucrose sweetness. Liquid drops of high intensity sweeteners are also available. These liquid forms are typically calibrated to deliver sweetness equivalent to one or more teaspoons of sucrose. Other forms of high intensity sweeteners include, for example, cubes bulked to provide a reasonable size with an inert or low calorie bulking material and sprays.

Although effective at providing sweetness to a foodstuff without the caloric burden of nutritive sweeteners, most high intensity sweeteners alone do not provide the same mouth feel as nutritive sweeteners. Various methods are known, however, to modify/control the mouth feel of high intensity sweeteners. For example, processes for preparing a sweetener containing a blend of gums, carriers, and aspartame that are lyophilized and formed into a “sugar cube” type form are known. We are unaware, however, of high intensity sweetener compositions for custom dosing of foodstuffs, which provide sweetness and a pleasing mouth feel to the foodstuff.

It would, therefore, be advantageous to provide a high intensity sweetener composition with a reduced caloric burden while maintaining the full taste, functionality, and physical properties of traditional sucrose. In particular, it would be advantageous to provide a high intensity sweetener composition that has a low caloric burden, improved mouth feel, and is in a form that is suitable for custom dosing. These and other objects of the present invention are described in greater detail below.

### SUMMARY OF THE INVENTION

One embodiment of the invention is a free-flowing powdered or granular sweetener composition comprising, consisting of, and/or consisting essentially of a high intensity sweetener and a food-grade gum.

Another embodiment of the invention is a free-flowing powdered or granular sweetener composition comprising, consisting of, and/or consisting essentially of a high intensity sweetener and a food-grade material selected from the group consisting of food-grade gums, carbohydrate polymers, glucose, fructose, sucrose, tagatose, and combinations thereof, wherein (a) a caloric content of the composition is less than about 0.5 calories per gram SES and (b) the total amount of the carbohydrate polymers, glucose, fructose, sucrose, tagatose, alone or in combination in the composition, is between about 0.0001% to about 98.5% by weight, based on the total weight of the composition.

A further embodiment of the invention is a foodstuff comprising, consisting of, and/or consisting essentially of a composition according to the present invention.

A further embodiment of the invention is a method for making a free-flowing powdered or granular sweetener composition. This method comprises, consists of, and/or consists essentially of combining a high intensity sweetener with a food-grade material selected from the group consisting of food-grade gums, carbohydrate polymers, glucose, fructose, sucrose, and combinations thereof.

A further embodiment of the invention is a method of sweetening a foodstuff comprising, consisting of, and/or consisting essentially of combining the composition according to the present invention with a food or beverage product.

A further embodiment of the invention is a sweetening kit comprising, consisting of, and/or consisting essentially of in packaged combination, a first container comprising a composition according to the present invention, a second container comprising an unsweetened foodstuff mix, and instructions for preparing the foodstuff therefrom.

### DETAILED DESCRIPTION OF THE INVENTION

One embodiment of the present invention is a free-flowing powdered or granular composition that includes a high intensity sweetener and a food-grade material. Food-grade materials, such as, carbohydrate polymers and small amounts of glucose, fructose, sucrose, and combinations may be included in the compositions to further improve mouth feel. Indeed, unexpectedly and surprisingly, the solid free-flowing sweetener compositions of the present invention when combined with a foodstuff provide an improved mouth feel, while maintaining the low calorie nature of the composition, when compared by consumers to the same foodstuff sweetened only with a high intensity sweetener. The compositions of the present invention are also provided in a form that allows for custom dosing of a foodstuff.

As used herein, unless otherwise indicated, the term “food-grade material” means a carbohydrate polymer and small amounts of glucose, fructose, sucrose, tagatose, and combinations thereof that are safe for use in a solid food or beverage. Standards for determining whether materials are safe for human consumption are set forth in the Codex Alimentarius produced by the World Health Organization (1999), which is incorporated by reference herein as if recited in full. In the present invention, the food-grade material, when combined with a high intensity sweetener, must provide a composition in a form that may be delivered to a solid food or beverage in customizable units, such as, a free-flowing powder or granular form. In addition, the food-grade material, when combined with a high intensity sweetener, must provide a pleasing mouth to feel the solid food or beverage to which it is added.

As used herein, unless otherwise indicated, the term “food-grade gum” means any food-grade material that has the properties of a gum; and when combined with a high intensity sweetener is able to be formed into a free-flowing powder or a free-flowing granular form and is able to impart a pleasing mouth feel to a foodstuff. Examples of food-grade gums include pullan, gum arabic, gum karaya, gum tragacanth, gum ghatti, agar-agar, guar gum, locust bean gum, konjac, alginates, carrageenans, pectin, tara gum, xanthan gum, gellan gum, pullulan, curdlan, cellulose microcrystalline cellulose (MCC), carboxymethylcellulose (CMC) gum, methylcellulose (MC), hydroxypropyl methylcellulose (HPMC), gelatin, chitosan, and combinations thereof. Preferably, the food-grade gum is guar gum, pectin, gum arabic, or CMC gum.

As used herein, unless otherwise indicated, the term “carbohydrate polymer” means any food-grade polymeric compound that is made up of simple sugars; and when combined with a high intensity sweetener is able to be formed into, a free-flowing powder or a free-flowing granular form and is able to impart a pleasing mouth feel to a foodstuff. Examples of carbohydrate polymers include glucans, fructans, galactans, arabinogalactans, arabinoxylans, xylans, pectin, and combinations thereof. Fructo-oligosaccharide is an example of an a fructan useful in the present invention. Polydextrose is an example of an a glucan useful in the present invention.

As used herein, unless otherwise indicated, the term “high intensity sweetener” means a substance that provides a high sweetness per unit mass as compared to a nutritive sweetener and provides little or no nutritive value. Many high intensity sweeteners are known to those skilled in the art and any may be used in the present invention. High intensity sweeteners useful in the present invention include aspartame, acesulfame, saccharine, cyclamate, neotame, sucralose, brazzein, and other protein based sweeteners, such as, stevia and other plant extracts, salts, derivatives, and combinations thereof. A preferred sweetener according to the present invention is sucralose.

The intensity of a high intensity sweetener may be assessed by determining the amount of the sweetener required to provide a sweetness comparable to a predetermined mass of a natural sugar, e.g., sucrose. In the present invention, this parameter is expressed in terms of “sucrose equivalent sweetness” (SES). For example, if a high intensity sweetener is twice as intense as sucrose, 0.5 g of the high intensity sweetener would equal 1.0 g of sucrose equivalent sweetness. Because the high intensity sweetener compositions of the present invention are provided in a customizable form as a free-flowing powder or as free-flowing granules, manufacturers and consumers are able to precisely control the amount of the sweetener composition incorporated into a foodstuff. Thus, the present compositions are extremely versatile and may be matched to specific applications, e.g., for use with a particular cookie or cake mix, cookie dough, beverage, or beverage mix, including powdered drink mixes, such as for example, KOOL-AID®, and chocolate mix. In addition, compositions of the present invention may be packaged together with an unsweetened solid food or beverage gas, allowing the consumer to control the amount of sweetness.

The free-flowing powdered or granular sweetener compositions of the present invention may provide a wide range of sweetness intensities from a fraction of that of sucrose to many times that of sucrose. An important aspect of the invention is a net low caloric content of the composition. Thus, one composition of the present invention provides a caloric density of less than 0.5 calories per gram of sucrose equivalent sweetness. Preferably, the composition provides a caloric density of less than 0.25 calories per gram of sucrose equivalent sweetness. More preferably, the composition provides a caloric density of less than 0.1 calorie per gram of sucrose equivalent sweetness.

As used herein, all numerical ranges provided are intended to expressly include at least all numbers that fall between the endpoints of ranges.

In another composition of the present invention, the free-flowing powdered or granular sweetener composition contains from about 0.001% to about 40% by weight of high intensity sweetener based on the total weight of the composition. More preferably, the free-flowing powdered or granular sweetener composition contains from about 0.5 to about 10% by weight of high intensity sweetener based on the total weight of the composition.

In the compositions of the present invention, the free-flowing powdered or granular sweetener composition contains from about 0.001 to about 90% by weight of food-grade material based on the total weight of the composition. More preferably, the free-flowing powdered or granular sweetener composition contains from about 0.005% to about 10% by weight of food-grade material based on the total weight of the composition. Other preferred ranges of the food-grade material include, for example, from about 0.025% to about 0.01% and from about 0.05% to about 0.1% by weight. In one preferred composition, about 0.1% (wt) of the food-grade material is present based on the total weight of the composition.

The compositions of the present invention may optionally contain other conventional food-grade additives including, for example, non-gum carriers, viscosity building non-gum materials, and bulking agents. Examples of bulking agents useful in the present invention include, for example, maltodextrin, fructo-oligosaccharide, polydextrose, inulin, fibersol, sugar alcohols, soluble fibers and the like, and combinations thereof. Preferred bulking agents are maltodextrin, fibersol, and inulin.

In the present compositions, the food-grade materials, in addition to improving mouth feel, may additionally function as carriers for the high intensity sweetener. When the gum functions as a carrier (eliminating the need for otherwise superfluous material) and provides the mouth feel normally found in a solid food or a beverage or beverage mix sweetened with a nutritive sweetener.

In another composition, the gum is first coated onto a non-gum carrier. Examples of non-gum carriers useful in the present invention include sucrose and maltodextrin. The gum may also be coated onto a viscosity building, non-gum material, such as, fructan and soluble fibers.

In yet another composition of the invention, both the gum and the high intensity sweetener are coated onto a carrier. This assures that both the gum and high intensity sweetener are dispersed and do not form clumps when mixed into a solid food or a beverage.

Another embodiment of the present invention is a free-flowing powdered or granular sweetener composition that includes a high intensity sweetener, a food-grade gum, and a food-grade material selected from carbohydrate polymers, glucose, fructose, sucrose, tagatose, and combinations thereof. In this composition, the caloric content of the composition is less than about 0.5 calories per gram SES and the total amount of the food-grade material in the composition is between about 0.0001% to 98.5% by weight, based on the weight of the composition. The identities and preferred amounts of the high intensity sweetener(s), food-grade gum(s), and food-grade material(s) in the composition are as defined above.

This composition, when combined with a solid food or beverage, provides a “Mouth Feel Score” greater than 5 to the solid food or beverage. As used herein, a “Mouth Feel Score” refers to the result of carrying out an art-recognized test for quantifying certain organoleptic properties of a foodstuff. In particular, “Mouth Feel Score” is defined by a blind, randomized consumer test in which at least three panellists (such as, for example, 4, 5, 6, 7, 8, 9, or 10 panellists) drink eight ounces of a test beverage and eight ounces of a control beverage. The test beverage is designed to have an equivalent sweetness to the control beverage. The beverages are rated based on three textural dimensions—“thickness,” “sliminess,” and “gumminess”—that relate to mouth feel using the following scales:

TABLE 1
Mouth Feel Scales

| | |
|---|---|
| Description | Score |

Scale A

| | |
|---|---|
| The test beverage is very much thinner than the control | 0 |
| beverage (water like) | |
| The test beverage is much thinner than the control | 4 |
| beverage | |
| The test beverage is thinner than the control beverage | 7 |
| The test beverage is slightly thinner than the control | 9 |
| beverage | |
| The test beverage is neither thicker nor thinner than | 10 |
| the control beverage | |
| The test beverage is slightly thicker than the control | 9 |
| beverage | |
| The test beverage is thicker than the control beverage | 7 |
| The test beverage is much thicker than the control | 4 |
| beverage | |
| The test beverage is very much thicker than the control | 0 |
| (syrup like) beverage | |

Scale B

| | |
|---|---|
| The test beverage is much less “slimy” than the | −3 |
| control | |
| The test beverage is less “slimy” than the control | −2 |
| The test beverage is slightly less “slimy” than | −1 |
| the control | |
| The test beverage is neither more or less “slimy” | 0 |
| than the control | |
| The test beverage is slightly more “slimy” than | −1 |
| the control | |
| The test beverage is more “slimy” than the control | −2 |
| The test beverage is much more “slimy” than the | −3 |
| control | |

Scale C

| | |
|---|---|
| The test beverage is much less “gummy” than the | −3 |
| control | |
| The test beverage is less “gummy” than the control | −2 |
| The test beverage is slightly less “gummy” than | −1 |
| the control | |
| The test beverage is neither more or less “gummy” | 0 |
| than the control | |
| The test beverage is slightly more “gummy” than | −1 |
| the control | |
| The test beverage is more “gummy” than the control | −2 |
| The test beverage is much more “gummy” than the | −3 |
| control | |

The Mouth Feel Score is calculated using Formula I:
Mouth Feel Score=Scale A Score+Scale B Score+Scale C Score (Formula I)

Compositions of the present invention having a Mouth Feel Score of greater than 5 (using the above test) provide a mouth feel similar to, e.g., a beverage sweetened with a nutritive sweetener, while providing a much lower caloric intake. Thus, in the present invention, a Mouth Feel Score (using the above test) of greater than 5 is preferred. For example, Mouth Feel Scores of 6, 7, 8, 9, or 10 are also preferred.

The compositions of the present invention may be delivered in any packaged form typically used for delivering a high intensity sweetener. Generally, the compositions of the present invention may be packaged for industrial or commercial use, such as in the food services industry, or for use by consumers in the same manner as other high intensity sweeteners (e.g., a unit dose quantity). The compositions of the present invention may be packaged in any useful quantity, such as, for example, one teaspoon, one quart, one cup, one pint, one pound, one gram, one kilogram, etc. of sucrose equivalent sweetness. These packaged forms may include, for example, boxes, bags, drums, tubs, pouches, containers, jars, and the like, and individual use (i.e., unit package) forms, such as packets or combinations thereof (e.g., a tub or a box containing individual packets). These packaged forms may further include, for example, a container, which is further packaged in a multi-container package or a container that is over-wrapped with a secondary packing material. The composition can be sold to consumers individually, or a part of a multi-container unit.

The packaging used to store a composition of the present invention is not critical, but may be composed of a coated paper, which is folded and sealed to create a small pouch. The coating on the paper is designed to protect the material in the package from environmental conditions that may affect the composition's stability and quality, such as, odors, moisture, oxygen, and atmospheric contaminants. Coatings that are appropriate for such packaging are well known in the art, and include, for example, low density polyethylene (LDPE).

The compositions of the present invention may be incorporated into various solid foods and beverages including, for example, premixed foodstuffs, in the same manner as sugar. Such premixed foodstuffs include, for example, cookie or cake mixes, cookie dough, and beverage pre-mixes. Foodstuffs of this type will provide the same convenience as those containing sugar, but have the advantage of delivering fewer calories.

The present invention also provides a kit for sweetening foodstuffs (i.e., a “sweetening kit”). The sweetening kit includes, in packaged combination, a first container, which contains a free-flowing powdered or granular sweetener composition of the present invention and a second container that contains an unsweetened foodstuff, and instructions for preparing such a foodstuff (i.e., cookie or cake mixes, cookie dough, and beverage pre-mixes). The instructions include directions on how to, e.g., reconstitute a beverage pre-mix and sweeten it to taste.

A further embodiment of the present invention is a method of making a free-flowing powdered or granular sweetener composition. This method includes combining a high intensity sweetener with a food-grade material selected from food-grade gums, carbohydrate polymers, glucose, fructose, sucrose, and combinations thereof. The amount and identity of the high intensity sweetener and food-grade material used in this method are as described above. In this method, the composition thus formed provides a Mouth Feel Score of at least 5 to a foodstuff. In this method, the combining step includes conventional methods for creating free-flowing powders or granules, such as, for example, dry mixing, spray drying, agglomeration, panning, co-crystallization, and the like.

Another embodiment of the invention is a method of sweetening a solid food or beverage. This method includes combining a composition of the present invention with a solid food or beverage product.

The following examples are provided to further illustrate the compositions and methods of the present invention. These examples are illustrative only and are not intended to limit the scope of the invention in any way.

### EXAMPLES

### Example 1

### Organoleptic Properties of SPLENDA® Brand No Calorie Sweetener-Gum Compositions

Each experimental composition contains SPLENDA® Brand No Calorie Sweetener (from McNeil Nutritionals LLC) and one of the following food-grade gums: (1) guar gum (178 Danisco GT-040); (2) pectin (Pectin Grinsted AMD-680 Danisco); and (3) avicel-CMC-cellulose gum (2159 FMC). Each experimental composition is prepared by blending the following dry ingredients:

TABLE 2
Experimental Formulations 1-9

| | | | | SPLENDA ® Brand |
|---|---|---|---|---|
| | Guar Gum | Pectin | CMC | No Calorie |
| Formulation | (% wt) | (% wt) | (% wt) | Sweetener (% wt) |
| 1 | 0.005 | — | — | 0.75 |
| 2 | 0.01 | — | — | 0.75 |
| 3 | 0.025 | — | — | 0.75 |
| 4 | — | 0.01 | — | 0.75 |
| 5 | — | 0.05 | — | 0.75 |
| 6 | — | 0.1 | — | 0.75 |
| 7 | — | — | 0.01 | 0.75 |
| 8 | — | — | 0.05 | 0.75 |
| 9 | — | — | 0.1 | 0.75 |

As a control, a solution of 5% (by weight) sucrose in water is made. Each experimental formulation is completely dissolved in freshly prepared hot tea (PG Tips (Unilever) (1 tea bag in 150 ml for two minutes) and hot coffee (Nescafe Original (Nestle), 5 teaspoons in 1 L water) for sensory analysis. Control tea and coffee samples are prepared by adding a sufficient quantity of the sucrose solution to attain the same sweetness level of the experimental formulations.

Each formulation (experimental and control) for both coffee and tea are presented to four to six panellists in random order, designed to minimize order bias, in identical looking plastic cups. The panellists are then asked to assess each formulation

Each panellist is asked to evaluate the intensity of thickness, sliminess, and gumminess of each formulation in the hot tea and coffee, respectively. In this test, the panellists use a scale from 1-10, which is anchored on each end with the descriptors “not” (1) and “very” (10), respectively. The panellists also record their overall preference for each formulation in coffee and tea, respectively using a 1-5 scale, which is anchored at each end with the descriptors “dislike” (1) and “like” (5), respectively.

The results are summarized in Tables 3-5, below. The median score for each attribute is used because of the observed high standard deviation around the mean.

TABLE 3
Guar gum

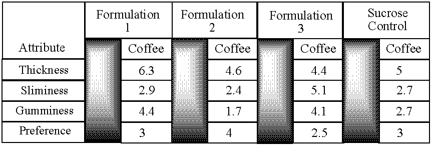

The results in Table 3 demonstrate that compositions of the present invention containing the high intensity sweetener, SPLENDA® Brand No Calorie Sweetener, and guar gum are perceived to be substantially the same as, or better than, the control, sucrose, at sweetening tea (shaded columns) and coffee (unshaded columns). As the data show, the perception of each formulation in hot tea and hot coffee is different. Indeed, the results suggest that a panellist's preference for tea or coffee may have some effect on the results.

In hot tea, for example, the sucrose control is perceived to be less thick than Formulations 1 and 2 (i.e., the 0.005% and 0.01% guar gum compositions). The sucrose control, however, is perceived as more “slimy” and “gummy” than Formulations 1-3 (i.e., all of the SPLENDA® Brand No Calorie Sweetener/guar gum compositions tested). In tea, each of the tested SPLENDA® Brand No Calorie Sweetener/guar gum compositions are preferred over the sucrose control. In hot coffee, however, the sucrose control is perceived to be similar in thickness, sliminess, and gumminess to Formulation 2 (0.01% SPLENDA® Brand No Calorie Sweetener/guar gum), which is the most preferred formulation (even compared to the sucrose control).

TABLE 4
Pectin

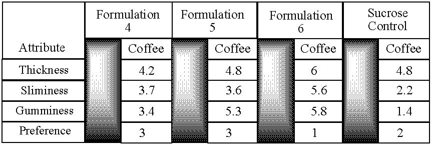

The results in Table 4 demonstrate that compositions of the present invention containing the high intensity sweetener, SPLENDA® Brand No Calorie Sweetener, and pectin are perceived to be approximately the same as, and, in certain cases, better than, the control, sucrose, at sweetening tea (shaded columns) and coffee (unshaded columns). As the data show, the perception of each formulation in hot tea and hot coffee is different, although not as pronounced as the guar gum formulations in Table 3.

In hot tea, the data indicate a small preference among the panellists for the sucrose control compared to Formulations 4-6 (i.e., the SPLENDA® Brand No Calorie Sweetener/pectin gum compositions). As the data also show, in hot tea, the sucrose control samples are perceived to be less thick, less slimy, and less gummy compared to Formulations 4-6. The SPLENDA® Brand No Calorie Sweetener/pectin gum mixtures are found to generally increase in thickness, sliminess, and gumminess with increasing concentration of the gum.

In hot coffee, Formulations 4 and 5 (i.e., compositions containing 0.01% and 0.05% pectin gum) are preferred over the sucrose control. Formula 6 (i.e., composition containing 0.1% pectin gum) is perceived to be less desirable than the sucrose control.

TABLE 5
Avicel-CMC-Cellulose Gum

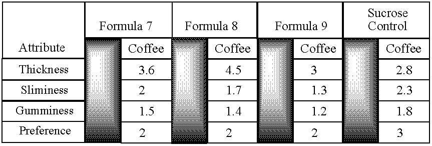

The results in Table 5 demonstrate that the panellists expressed little or no preference among the different formulations compared to the sucrose control in tea (shaded columns) and coffee (unshaded columns). The data also show that the perception of each formulation in hot tea and hot coffee is different. For example, the formulations are perceived to be much thicker in the hot tea compared to the hot coffee.

In hot tea, the sucrose control is assessed to be less thick, slimy, and gummy compared to all the CMC gum formulations. Nonetheless, Formulations 7 and 8 (i.e., 0.01% and 0.05%) are perceived to be similar in mouth feel to the sucrose control. In contrast, in hot coffee, although the sucrose control is perceived to be more gummy and slimy compared to Formulations 7-9, the control was preferred.

The data set forth above demonstrates that thickness is perceived differently in hot tea and coffee. The panellists generally scored Formulations 1-9 as more thick, slimy, and gummy in hot tea compared to hot coffee. This suggests that coffee may mask these attributes by its general bitterness. Overall, the results demonstrate that guar gum (at concentrations of 0.005% and 0.01%), pectin gum (at a concentration of 0.01%), and CMC gum (at a concentration of 0.1%) are perceived to be closest in mouth feel to the sucrose control.

### Example 2

### Organoleptic Properties of SPLENDA® Brand No Calorie Sweetener-Gum Compositions

In this experiment, each experimental composition is prepared by blending the following dry ingredients in the same manner as described in Example 1:

TABLE 6
Experimental Formulations 10-12

| | | | | SPLENDA ® Brand |
|---|---|---|---|---|
| | Guar Gum | Pectin | CMC | No Calorie |
| Formulation | (% wt) | (% wt) | (% wt) | Sweetener (% wt) |
| 10 | 0.01 | — | — | 0.75 |
| 11 | — | 0.01 | — | 0.75 |
| 12 | — | — | 0.01 | 0.75 |

As in Example 1, a sucrose control containing 5% (wt) sucrose in water is prepared. In addition, a SPLENDA® Brand No Calorie Sweetener control is also prepared containing 0.01% (wt) sucralose in water. Hot tea and coffee are prepared as in Example 1. Formulations 10-12, as well as, the sucrose and SPLENDA® Brand No Calorie Sweetener controls are added to the freshly prepared coffee and tea, respectively as described in Example 1. Each sample is assessed in the same manner as described in Example 1. The results are set forth in Table 7, below.

TABLE 7

| | Sucrose | | Sucralose | | Form. 10 | | Form. 11 | | Form. 12 | |
|---|---|---|---|---|---|---|---|---|---|---|
| Attribute | Tea | Coffee | Tea | Coffee | Tea | Coffee | Tea | Coffee | Tea | Coffee |
| Thickness | 3.78 | 3.3 | 2.55 | 2.9 | 4.88 | 3.55 | 2.25 | 2.6 | 4.18 | 3.45 |
| Sliminess | 2.25 | 1.9 | 1.45 | 1.9 | 1.3 | 2.23 | 1.38 | 1.1 | 1.9 | 1.9 |
| Gumminess | 1.73 | 1.6 | 1.63 | 1.8 | 1.4 | 1.7 | 1.63 | 1.05 | 2.03 | 1.95 |
| Preference | 2.5 | 3 | 2.5 | 3 | 3 | 3 | 3.5 | 2.5 | 3 | 3 |

In hot tea, the data from Table 7 show that all three compositions according to the present invention (i.e., Formulations 10-12) are preferred over the sucrose and the SPLENDA® Brand No Calorie Sweetener controls. In hot coffee, all three compositions according to the present invention were rated substantially the same in preference compared to the controls.

In hot coffee, Formulation 12 (i.e., the SPLENDA® Brand No Calorie Sweetener/CMC gum composition) is rated similar in thickness, sliminess, and gumminess to the sucrose control. Formulation 10 (i.e., the SPLENDA® Brand No Calorie Sweetener/guar gum composition) is rated only slightly thicker compared to the sucrose control.

Formula 11 (i.e., the SPLENDA® Brand No Calorie Sweetener/pectin gum composition) is scored as being similar to the sucralose control, which has a lower thickness, sliminess, and gumminess compared to the sucrose control.

The scores in this example are generally lower compared to those in Example 1, however, variations are to be expected because different panellists are used in Example 2. What is important, however, is the favorable mouth feel comparison between Formulations 10-12 and the controls within this experiment.

This example demonstrates that compositions containing 0.01% guar gum and CMC gum, respectively provide mouth feel values comparable to the control sucrose. Indeed, in hot tea, all of the three gum compositions are preferred compared to both the sucrose and SPLENDA® Brand No Calorie Sweetener controls. In hot coffee, there is no significant difference between the three compositions according to the present invention and the sucrose and sucralose controls.

### Example 3

### Mouth Feel Scores

This experiment assesses the difference in perceived Mouth Feel of Guar gum (178 Danisco GT-040) mixed with SPLENDA® Brand No Calorie Sweetener, Pectin (Grinsted AMD-680 Danisco) mixed with SPLENDA® Brand No Calorie Sweetener, and Avicel-CMC-cellulose gum (2159 FMC) mixed with SPLENDA® Brand No Calorie Sweetener compared to sucrose and SPLENDA® Brand No Calorie Sweetener controls. Mouth Feel scores are also assessed against a sucrose control when 1 calorie equivalent of sucrose per gram is added to each of the above-identified compositions.

Each experimental formulation in this example is prepared by blending the following dry ingredients in the same manner as described in Example 1, with the exception that the % weight of SPLENDA® Brand No Calorie Sweetener is adjusted to reach a similar sweetness level to the sucrose control.

TABLE 8
Experimental Formulations 13-18

| | | | | SPLENDA ® | |
|---|---|---|---|---|---|
| | | | | Brand | |
| | | | | No Calorie | |
| | Guar Gum | Pectin | CMC | Sweetener | Sucrose |
| Formulation | (% wt) | (% wt) | (% wt) | (% wt) | (% wt) |
| 13 | 0.01 | — | — | 0.75 | — |
| 14 | — | 0.01 | — | 0.75 | — |
| 15 | — | — | 0.01 | 0.75 | — |
| 16 | 0.01 | — | — | 0.75 | 0.125 |
| 17 | — | 0.01 | — | 0.75 | 0.125 |
| 18 | — | — | 0.01 | 0.75 | 0.125 |

As in Example 1, a sucrose control containing 5% (wt) sucrose in water is prepared. In addition, a SPLENDA® Brand No Calorie Sweetener control is also prepared containing 0.01% (wt) SPLENDA® Brand No Calorie Sweetener in water. Hot tea and coffee prepared as in Example 1. Formulations 13-18, as well as, the sucrose and SPLENDA® Brand No Calorie Sweetener controls are added to the freshly prepared coffee and tea, respectively as described in Example 1.

In this example, four panellists were used. In each experiment, the panellists are asked to evaluate the Mouth Feel of hot coffee and tea supplemented with each of the experimental formulations and controls using the Mouth Feel Scale of Table 1. Mouth Feel Scores are calculated according to Formula I. The mean of the Mouth Feel Scores for each panellist for each sample is calculated and is set forth in Tables 9 and 10, below.

TABLE 9
Mouth Feel Scores (With No Sucrose Added)

| | | | SPLENDA ® Brand | | | | | | | |
|---|---|---|---|---|---|---|---|---|---|---|
| | Sucrose | | No Calorie | | Formulation | | Formulation | | Formulation | |
| Mouth feel | Control | | Sweetener Control | | 13 | | 14 | | 15 | |
| Score | Tea | Coffee | Tea | Coffee | Tea | Coffee | Tea | Coffee | Tea | Coffee |
| Median | 10 | 10 | 7 | 8.5 | 6 | 6 | 9 | 8.5 | 7 | 7.5 |

The results in Table 9 demonstrate that in both hot tea and hot coffee, Formulation 14 (i.e., the SPLENDA® Brand No Calorie Sweetener-pectin composition) is perceived as closest in mouth feel to the sucrose control. Formulation 15 (i.e., the SPLENDA® Brand No Calorie Sweetener-CMC gum composition) is perceived as closer to the SPLENDA® Brand No Calorie Sweetener control (i.e., no added gum). Formula 13 (i.e., the Splenda®-guar gum composition) is perceived as having the biggest Mouth Feel difference compared to the controls.

TABLE 10
Mouth Feel Scores (With Sucrose)

| | | | SPLENDA ® Brand | | | | | | | |
|---|---|---|---|---|---|---|---|---|---|---|
| | Sucrose | | No Calorie | | Formulation | | Formulation | | Formulation | |
| Mouth Feel | Control | | Sweetener Control | | 16 | | 17 | | 18 | |
| Score | Tea | Coffee | Tea | Coffee | Tea | Coffee | Tea | Coffee | Tea | Coffee |
| Median | 10 | 10 | 6 | 7.5 | 5 | 7 | 8 | 7.5 | 6 | 4.5 |

The results in Table 10 demonstrate that Formulation 17 (i.e., the SPLENDA® Brand No Calorie Sweetener-pectin-sucrose composition) is perceived as closest to the sucrose control (for both hot tea and coffee). Formulations 16 and 18 (i.e., the guar gum- and CMC-containing compositions, respectively) have lower Mouth Feel Scores compared to both sucrose and SPLENDA® Brand No Calorie Sweetener controls. The Mouth Feel Scores of Formulations 16-18 (sucrose supplemented compositions) are lower than Formulations 13-15 (no sucrose supplementation). Using the Mouth Feel Scales of Table 1 and Formula I, the Mouth Feel Scores generated demonstrate that the Splenda®-pectin compositions (i.e., Formulations 14/17) are closer in mouth feel to the controls than either the SPLENDA® Brand No Calorie Sweetener-guar gum or SPLENDA® Brand No Calorie Sweetener-CMC gum compositions (Formulations 13/16 and 15/18, respectively). Nonetheless, with the exception of Formulation 18 in hot coffee, all of the Formulations have Mouth Feel Scores that are sufficient to be used as sugar substitutes in various foodstuffs.

The scope of the present invention is not limited by the description, examples and suggested uses herein and modifications may be made without departing from the spirit of the invention. Thus, it is intended that the present invention cover modifications and variations of this invention provided that they come within the scope of the appended claims and their equivalents.

What is claimed is:

1. A free-flowing powdered or granular sweetener composition comprising a high intensity sweetener and a food-grade gum.

2. The composition according to claim 1, wherein the composition provides a Mouth Feel Score greater than 5 to a solid food or beverage.

3. The composition according to claim 2, further comprising a food-grade material selected from the group consisting of carbohydrate polymers, glucose, fructose, sucrose, and combinations thereof.

4. The composition according to claim 2, wherein the high intensity sweetener is selected from the group consisting of aspartame, acesulfame, saccharine, cyclamate, neotame, sucralose, brazzein, stevia, salts, derivatives, and combinations thereof.

5. A composition according to claim 4, wherein the high intensity sweetener is sucralose.

6. A composition according to claim 2, wherein the food-grade gum is selected from the group consisting of pullan, gum arabic, gum karaya, gum tragacanth, gum ghatti, agar-agar, guar gum, locust bean gum, konjac, alginates, carrageenans, pectin, tara gum, xanthan gum, gellan gum, pullulan, curdlan, cellulose microcrystalline cellulose, carboxymethylcellulose gum, methylcellulose, hydroxypropyl methylcellulose, gelatin, chitosan, and combinations thereof.

7. A composition according to claim 6, wherein the food-grade gum is guar gum.

8. A composition according to claim 6, wherein the food-grade gum is pectin.

9. A composition according to claim 6 wherein the food-grade gum is carboxymethylcellulose gum.

10. A composition according to claim 3, wherein the carbohydrate polymer is selected from the group consisting of glucan, fructan, galactan, arabinogalactan, xylan, arabinoxylan, and combinations thereof.

11. A composition according to claim 2, further comprising a food-grade additive selected from the group consisting of non-gum carriers, viscosity building non-gum materials, bulking agents, and combinations thereof.

12. A composition according to claim 3, wherein the food-grade material is present in an amount from about 0.001 to about 40% by weight, based on the total weight of the composition.

13. A composition according to claim 3, wherein the food-grade material is present in an amount from about 0.005% to about 1.0% by weight, based on the total weight of the composition.

14. A composition according to claim 3, wherein the food-grade material is present in an amount from about 0.025% to about 1.0% by weight, based on the total weight of the composition.

15. A composition according to claim 3, wherein the food-grade material is present in an amount from about 0.05% to about 0.1% by weight, based on the total weight of the composition.

16. A composition according to claim 1, wherein about 0.1% by weight of the food-grade material is present in the composition.

17. A composition according to claim 1, wherein the composition provides less than 0.5 calories per gram of sucrose equivalent sweetness.

18. A composition according to claim 1, wherein the composition provides less than 0.25 calories per gram of sucrose equivalent sweetness.

19. A composition according to claim 1, wherein the composition provides less than 0.1 calorie per gram of sucrose equivalent sweetness.

20. A free-flowing powdered or granular sweetener composition comprising a high intensity sweetener, a food-grade gum, and a food-grade material selected from the group consisting of carbohydrate polymers, glucose, fructose, sucrose, tagatose, and combinations thereof, wherein (a) the caloric content of the composition is less than about 0.5 calories per gram sucrose equivalent sweetness and (b) the total amount of the food-grade material in the composition, is between about 0.0001% to about 98.5% by weight, based on the total weight of the composition.

21. The composition according to claim 20, wherein the composition provides a Mouth Feel Score greater than 5 to a solid food or beverage.

22. The composition according to claim 21, wherein the total amount of the carbohydrate polymers, glucose, fructose, sucrose, tagatose, alone or in combination in the composition, is between about 0.001% to about 98.5% by weight, based on the total weight of the composition.

23. The composition according to claim 22, wherein the total amount of the carbohydrate polymers, glucose, fructose, sucrose, tagatose, alone or in combination in the composition, is between about 0.001% to about 95% by weight, based on the total weight of the composition.

24. The composition according to claim 23, wherein the total amount of the carbohydrate polymers, glucose, fructose, sucrose, tagatose, alone or in combination in the composition, is between about 0.001% to about 50% by weight, based on the total weight of the composition.

25. The composition according to claim 21, wherein the total amount of the carbohydrate polymers, glucose, fructose, sucrose, tagatose, alone or in combination in the composition, is about 0.5% by weight, based on the total weight of the composition.

26. The composition according to claim 21, wherein the total amount of the carbohydrate polymers, glucose, fructose, sucrose, tagatose, alone or in combination in the composition, is about 0.25% by weight, based on the total weight of the composition.

27. The composition according to claim 21, wherein the total amount of the carbohydrate polymers, glucose, fructose, sucrose, tagatose, alone or in combination in the composition, is about 0.1% by weight, based on the total weight of the composition.

28. The composition according to claim 21, wherein the high intensity sweetener is selected from the group consisting of aspartame, acesulfame, saccharine, cyclamate, neotame, sucralose, brazzein, stevia, salts thereof, and combinations thereof.

29. A composition according to claim 28, wherein the high intensity sweetener is sucralose.

30. A composition according to claim 21, wherein the food-grade gum is selected from the group consisting of pullan, gum arabic, gum karaya, gum tragacanth, gum ghatti, agar-agar, guar gum, locust bean gum, konjac, alginates, carrageenans, pectin, tara gum, xanthan gum, gellan gum, pullulan, curdlan, cellulose microcrystalline cellulose carboxymethylcellulose gum, methylcellulose, hydroxypropyl methylcellulose, gelatin, chitosan, and combinations thereof.

31. A composition according to claim 30, wherein the food-grade gum is guar gum.

32. A composition according to claim 30, wherein the food-grade gum is pectin.

33. A composition according to claim 30, wherein the food-grade gum is carboxymethylcellulose gum.

34. A composition according to claim 21, wherein the carbohydrate polymer is selected from the group consisting of glucan, fructan, galactan, arabinogalactan, xylan, arabinoxylan, and combinations thereof.

35. A composition according to claim 21, further comprising a food-grade additive selected from the group consisting of non-gum carriers, viscosity building non-gum materials, bulking agents, and combinations thereof.

36. A composition according to claim 21, wherein the composition provides less than 0.5 calories per gram of sucrose equivalent sweetness.

37. A composition according to claim 21, wherein the composition provides less than 0.25 calories per gram of sucrose equivalent sweetness.

38. A composition according to claim 21, wherein the composition provides less than 0.1 calorie per gram of sucrose equivalent sweetness.

39. A foodstuff comprising a composition according to claim 1 or claim 20.

40. A method for making a free-flowing powdered or granular sweetener composition comprising combining a high intensity sweetener with a food-grade material selected from the group consisting of a food-grade gum, a carbohydrate polymer, glucose, fructose, sucrose, and combinations thereof.

41. The method according to claim 40, wherein the composition provides a Mouth Feel Score greater than 5.

42. A method of sweetening solid food or beverage comprising combining the composition of claim 1 or claim 20 with a solid food or beverage.

43. A sweetening kit comprising, in packaged combination, a first container comprising the composition of claim 1 or claim 20, a second container comprising an unsweetened foodstuff mix, and instructions for preparing the solid food or beverage therefrom.
